(19) United States
(12) Patent Application Publication
(10) Pub. No.: US 2015/0380039 A1
(43) Pub. Date: Dec. 31, 2015

(54) OPTICAL INFORMATION REPRODUCTION DEVICE AND OPTICAL INFORMATION RECORDING AND REPRODUCING DEVICE

(71) Applicants: Yusuke NAKAMURA, Tokyo (JP); Toshiki ISHII, Tokyo (JP)

(72) Inventors: Yusuke NAKAMURA, Tokyo (JP); Toshiki ISHII, Tokyo (JP)

(21) Appl. No.: 14/769,696

(22) PCT Filed: Mar. 27, 2013
(86) PCT No.: PCT/JP2013/058905

§ 371 Date: Aug. 21, 2015

(51) Int. Cl. G11B 7/0065; G01B 11/14

(52) U.S. Cl. CPC G11B 7/0065; G01B 11/14

(57) ABSTRACT

A position control method at high speed and high accuracy for recorded hologram is obtained. An optical information recording and reproducing device records an interference fringe obtained by interfering reference beam and signal beam as a hologram on an optical information recording medium and reproduces information using the reference beam from the hologram recorded on the optical information recording medium. The optical information recording and reproducing device includes: a detection light generation unit that generates light including a part of the signal beam as detection light; a detection light incident unit that causes the detection light to be incident on the recorded hologram; and a light detection unit that detects a light amount of diffracted beam by the detection light incident on the hologram. A position of the recorded hologram is detected based on an output of the light detection unit.

### TECHNICAL FIELD

The present invention relates to an optical information reproducing device, an optical information recording and reproducing device, an optical information reproducing method, and an optical information recording and reproducing method of recording information on an optical information recording medium and reproducing information from an optical information recording medium using holography.

### BACKGROUND ART

At present, optical discs with a recording density of about 50 GB have been commercialized even for consumers by the Blu-ray Disc™ standard using semiconductor blue-violet lasers. In future, even for optical discs, it is desirable to increase capacities up to the same capacities as hard disk drive (HDD) capacities of about 100 GB to 1 TB.

In order to realize such very high densities by an optical disc, however, high-density technologies by new schemes different from high-density technologies by short wavelength and high NA of object lens are necessary.

While next-generation storage technologies are studied, hologram recording technologies for recording digital information using holography have been noticed.

The hologram recording technology refers to a technology for recording information in the recording medium by superposing signal beam with information regarding page data modulated 2-dimensionally by a spatial light modulator on reference beam inside a recording medium and causing refractive index modulation inside the recording medium by an interference pattern occurring at that time.

At the time of reproducing information, a hologram recorded on a recording medium operates like a diffraction grating and a diffracted beam is generated when the recording medium is exposed to reference beam used at the time of recording. The diffracted beam is reproduced as the same light, including the recorded signal beam and phase information.

The reproduced signal beam is detected 2-dimensionally at a high speed using a light detector such as a CMOS or a CCD. In this way, the hologram recording technology can serve to perform recording and reproducing information with a high capacity and at a high speed since the hologram recording technology enables 2-dimensional information to be recorded on an optical recording medium at a time by one hologram and further enables the information to be reproduced and a plurality of pieces of page data can be overwritten at a certain location of a recording medium.

A hologram recording technology is disclosed in, for example, JP-A-2004-272268 (PTL 1). This publication discloses a technology for multiplexing and recording a hologram.

### CITATION LIST

### Patent Literature

PTL 1: JP-A-2004-272268

### SUMMARY OF INVENTION

### Technical Problem

Incidentally, in a recording and reproducing device using holography of an angle multiplex scheme, positioning is performed in the periphery of the hologram to gain access to the recorded target hologram, and then minute adjustment of a position is performed while confirming signal quality of the hologram. Therefore, there is a problem in that it takes access time.

### Solution to Problem

The foregoing program can be achieved by causing detection light for detecting position deviation to be incident on a recording medium from an optical path of signal beam at the time of recording and detecting a diffracted beam.

### Advantageous Effects of Invention

According to the invention, access to a recorded target hologram can be performed at a high speed, and thus a conveniently usable optical information recording and reproducing device can be provided.

### BRIEF DESCRIPTION OF DRAWINGS

FIG. 1 is a schematic diagram illustrating an embodiment of a pickup in an optical information recording and reproducing device.

FIG. 2 is a schematic diagram illustrating an embodiment of an optical information recording and reproducing device.

FIG. 3 is a schematic diagram illustrating an embodiment of a pickup in an optical information recording and reproducing device.

FIG. 4 is a schematic diagram illustrating an embodiment of a pickup in an optical information recording and reproducing device.

FIG. 5 is a schematic diagram illustrating an embodiment of a pickup in an optical information recording and reproducing device.

FIG. 6 is a schematic diagram illustrating an embodiment of an operation flow of the optical information recording and reproducing device.

FIG. 7 is a schematic diagram illustrating an embodiment of a signal generation circuit in the optical information recording and reproducing device.

FIG. 8 is a schematic diagram illustrating an embodiment of a signal processing circuit in the optical information recording and reproducing device.

FIG. 9 is a schematic diagram illustrating an embodiment of an operation flow of the signal generation circuit and the signal processing circuit.

FIG. 10 is a diagram illustrating an embodiment of a display image of a spatial light modulator at the time of a recording operation.

FIG. 11 is a diagram illustrating an embodiment of a display image of the spatial light modulator at the time of a position detection operation.

FIG. 12 is a diagram illustrating an embodiment of a display image of the spatial light modulator at the time of the position detection operation.

FIG. 13 is a diagram illustrating an embodiment of a display image of the spatial light modulator at the time of the position detection operation.

FIG. 14 is a diagram illustrating an embodiment of a mask.

FIG. 15 is a diagram illustrating an embodiment of a mask.

FIG. 16 is a diagram illustrating diffraction efficiency of a movement amount of an optical information recording medium.

FIG. 17 is a diagram illustrating diffraction efficiency of a movement amount of the optical information recording medium.

FIG. 18 is a schematic diagram illustrating an embodiment of a position detection optical system in the optical information recording and reproducing device.

FIG. 19 is a diagram illustrating an embodiment of a position detection signal in an X direction.

FIG. 20 is a diagram illustrating an embodiment of the position detection signal in a Y direction.

FIG. 21 is a diagram illustrating an embodiment of the flow of a position control operation at the time of the reproducing operation.

FIG. 22 is a diagram illustrating an embodiment of the flow of a position control operation at the time of the reproducing operation.

FIG. 23 is a schematic diagram illustrating an embodiment of a pickup in the optical information recording and reproducing device.

FIG. 24 is a diagram illustrating an embodiment of the flow of a position control operation at the time of the reproducing operation.

FIG. 25 is a diagram illustrating an embodiment of a display image of a spatial light modulator at the time of a search page recording operation.

FIG. 26 is a diagram illustrating an embodiment of a display image of the spatial light modulator at the time of a position detection operation.

FIG. 27 is a diagram illustrating an embodiment of a mask.

FIG. 28 is a diagram illustrating an embodiment of a book search signal.

FIG. 29 is a diagram illustrating an embodiment of the flow of a search page recording operation at the time of a recording operation.

FIG. 30 is a diagram illustrating an embodiment of the flow of a book search operation at the time of a reproducing operation.

FIG. 31 is a diagram illustrating an embodiment of the book search signal.

FIG. 32 is a diagram illustrating an embodiment of a display image of a spatial light modulator at the time of a recording operation.

FIG. 33 is a schematic diagram illustrating an embodiment of a position detection optical system in the optical information recording and reproducing device.

FIG. 34 is a diagram illustrating a position detection signal in a Z direction.

FIG. 35 is a schematic diagram illustrating the recording of a hologram between signal beam.

FIG. 36 is a schematic diagram illustrating the reproducing of the hologram between the signal beam.

FIG. 37 is a schematic diagram illustrating the recording of the hologram between the signal beam.

FIG. 38 is a schematic diagram illustrating the recording of the hologram between the signal beam.

### DESCRIPTION OF EMBODIMENTS

Hereinafter, embodiments of the invention will be described with reference to the drawings.

### First Embodiment

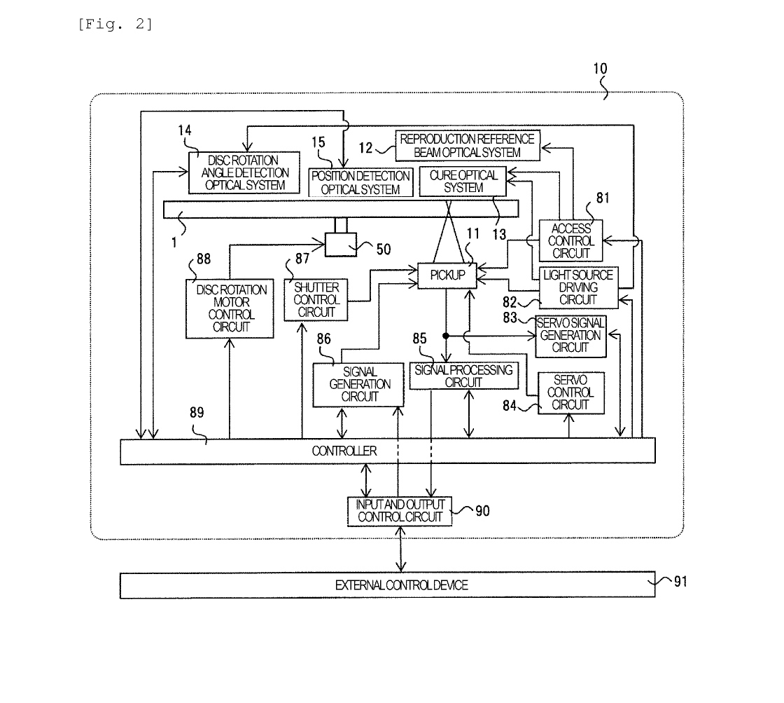

An embodiment of the invention will be descried with reference to the accompanying drawings. FIG. 2 is a block diagram illustrating a recording and reproducing device of an optical information recording medium that records and/or reproduces digital information using holography.

An optical information recording and reproducing device 10 is connected to an external control device 91 via an input and output control circuit 90. In the case of recording, the optical information recording and reproducing device 10 receives an information signal to be recorded from the external control device 91 by the input and output control circuit 90. In the case of reproducing, the optical information recording and reproducing device 10 transmits a reproduced information signal to the external control device 91 by the input and output control circuit 90.

The optical information recording and reproducing device 10 includes a pickup 11, a reproduction reference beam optical system 12, a cure optical system 13, a disc rotational angle detection optical system 14, a position detection optical system 15, and a rotational motor 50. An optical information recording medium 1 is configured to be able to be rotated by the rotational motor 50.

The pickup 11 serves to emit reference beam and signal beam to the optical information recording medium 1 and to record digital information on a recording medium using holography. At this time, an information signal to be recorded is sent to a spatial light modulator in the pickup 11 via a signal generation circuit 86 by a controller 89, so that the signal beam is modulated by the spatial light modulator.

When information recorded on the optical information recording medium 1 is reproduced, a light wave causing the reference beam emitted from the pickup 11 to be incident on an optical information recording medium in an opposite direction to a direction at the time of the recording is generated in a reproduction reference beam optical system 12. Reproduced light reproduced by reproduction reference beam is detected by a light detector to be described later in the pickup 11 and a signal is reproduced by a signal processing circuit 85.

An exposure time of the reference beam and the signal beam to which the optical information recording medium 1 is exposed can be adjusted by controlling opening and closing times of a shutter in the pickup 11 via a shutter control circuit 87 by the controller 89.

The cure optical system 13 serves to generate a light beam to be used for pre-cure and post-cure of the optical information recording medium 1. The pre-cure is a pre-process of exposing a predetermined light beam in advance before the reference beam and the signal beam are exposed to a desired position when information is recorded at a desired position in the optical information recording medium 1. The post-cure is a post-process of recording the information at the desired position in the optical information recording medium 1, and then exposing the predetermined light beam so that appending is not possible at the desired position.

The disc rotational angle detection optical system 14 is used to detect a rotational angle of the optical information recording medium 1. When the optical information recording medium 1 is adjusted at a predetermined rotational angle, the disc rotational angle detection optical system 14 detects a signal according to the rotational angle and the controller 89 can control the rotational angle of the optical information recording medium 1 using the detected signal via a disc rotation motor control circuit 88.

A predetermined light source driving current is supplied from a light source driving circuit 82 to light sources in the pickup 11, the cure optical system 13, and the disc rotational angle detection optical system 14, so that a light beam with a predetermined optical amount can be emitted from each light source.

In the pickup 11 and the disc cure optical system 13, a mechanism capable of sliding a position in a radial direction of the optical information recording medium 1 is provided so that position control is performed via an access control circuit 81.

Incidentally, in a recording technology using an angle multiplexing principle of holography, an allowable error tends to considerably decreases with respect to deviation of a reference optical angle.

Accordingly, it is necessary to provide a mechanism detecting a deviation amount of the reference optical angle in the pickup 11, generate a servo control signal in a servo signal generation circuit 83, and provide a servo mechanism correcting the deviation amount via a servo control circuit 84 in the optical information recording and reproducing device 10.

The pickup 11, the cure optical system 13, the disc rotational angle detection optical system 14, and the position detection optical system 15 may be configured in several optical system structures or all of the optical system configurations may be collected in one optical system for simplicity.

FIG. 3 is a diagram illustrating a recording principle in an example of a basic optical system structure of the pickup 11 in the optical information recording and reproducing device 10. A light beam emitted from a light source 301 is transmitted through a collimating lens 302 to be incident on a shutter 303. When the shutter 303 is opened, the light beam passes through the shutter 303. Thereafter, for example, after a polarization direction of the light beam is controlled so that a light amount ratio of p-polarized light to s-polarized light becomes a desired ratio by an optical element 304 including a half-wavelength plate and the like, the light beam is incident on a polarization beam splitter (PBS) prism 305.

The light beam transmitted through the PBS prism 305 works as signal beam 306. After a light beam diameter is expanded by a beam expander 308, the light beam is transmitted through a phase mask 309, a relay lens 310, and a PBS prism 311 to be incident on a spatial light modulator 312.

The signal beam to which information is added by the spatial light modulator 312 is reflected from the PBS prism 311 to propagate through a relay lens 313 and a spatial filter 314. Thereafter, the signal beam is condensed to the optical information recording medium 1 by an object lens 315.

On the other hand, the light beam reflected from the PBS prism 305 works as reference beam 307. After a predetermined polarization direction is set according to the time of recording or the time of reproducing by a polarization direction conversion element 316, the reference beam is incident on a galvanometer mirror 319 via mirrors 317 and 318. Since the galvanometer mirror 319 can adjust an angle using an actuator 320, an incident angle of the reference beam pas sing through the lens 321 and 322 and then incident on the optical information recording medium 1 can be set to a desired angle. To set the incident angle of the reference beam, an element converting a wave front of the reference beam may be used instead of the galvanometer mirror.

In this way, by causing the signal beam and the reference beam to be incident on the optical information recording medium so that the signal beam and the reference beam are superimposed, an interference pattern is formed inside the recording medium and information is recorded by writing this pattern on the recording medium. Since the incident angle of the reference beam incident on the optical information recording medium 1 can be changed by the galvanometer mirror 319, recording can be performed through angle multiplexing.

Thereafter, in regard to a hologram recorded by changing the reference beam angle in the same region, the hologram corresponding to each one reference beam angle is referred to as a page and a set of the pages subjected to the angle multiplexing in the same region is referred to as a book.

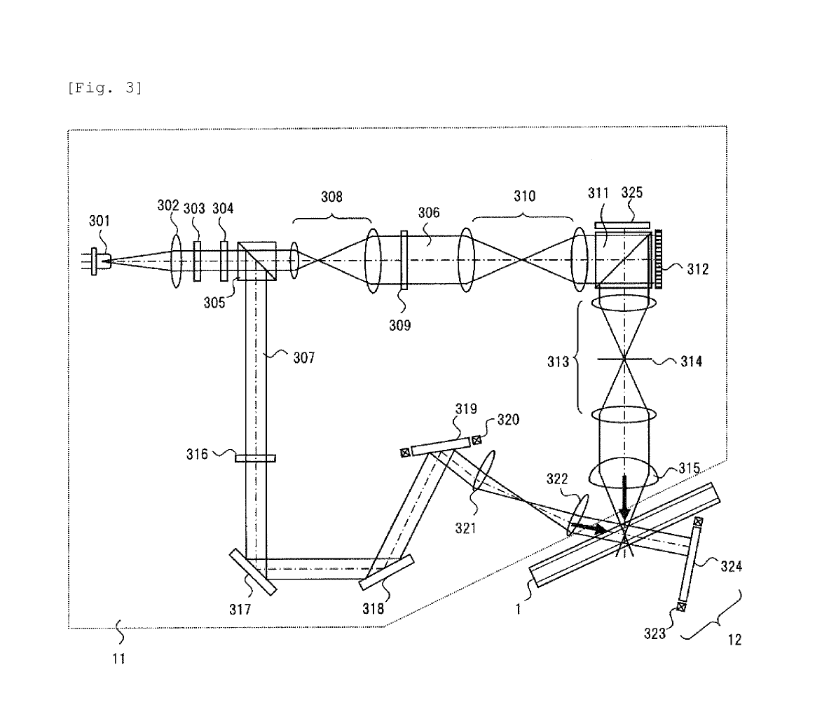

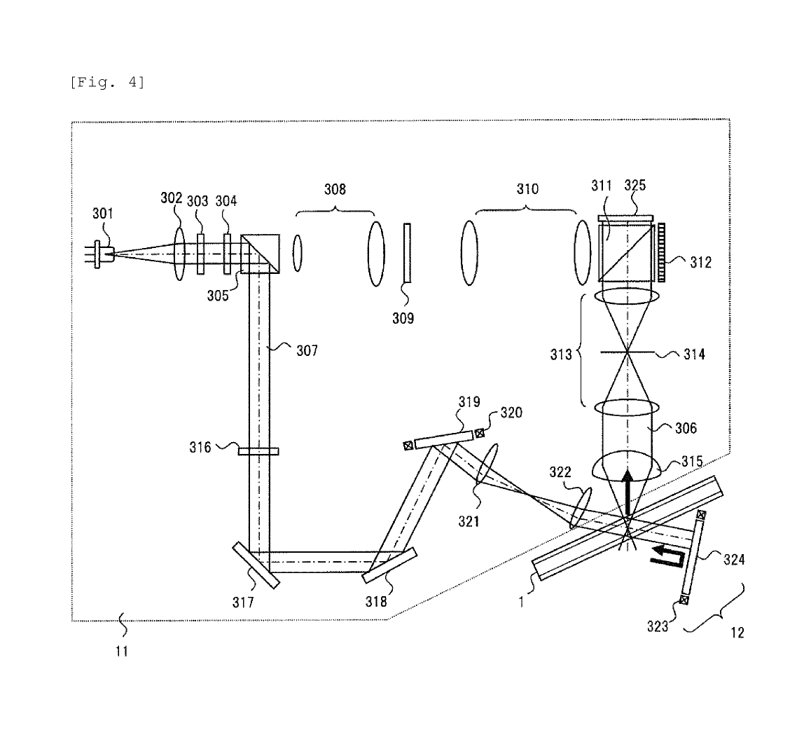

FIG. 4 is a diagram illustrating a reproducing principle in the example of the basic optical system structure of the pickup 11 in the optical information recording and reproducing device 10. When the recorded information is reproduced, reproduction reference beam is generated by causing the reference beam to be incident on the optical information recording medium 1 and reflecting the light beam transmitted through the optical information recording medium 1 from a galvanometer mirror 324 capable of adjusting an angle using an actuator 323, as described above.

Reproduced light reproduced from the reproduction reference beam propagates through the object lens 315, the relay lens 313, and the spatial filter 314. Thereafter, the reproduced light is transmitted through the PBS prism 311 and is incident on a light detector 325 so that the recorded signal can be reproduced. For example, an imaging element such as a CMOS image sensor or a CCD image sensor can be used as the light detector 325. Any element may be used as long as the element can reproduce page data.

FIG. 5 is a diagram illustrating another configuration of the pickup 11. In FIG. 5, a light beam emitted from a light source 501 is transmitted through a collimating lens 502 to be incident on a shutter 503. When the shutter 503 is opened, the light beam passes through the shutter 503. Thereafter, for example, after a polarization direction of the light beam is controlled so that a light amount ratio of p-polarized light to s-polarized light becomes a desired ratio by an optical element 504 including a half-wavelength plate and the like, the light beam is incident on a polarized beam splitter 505.

The light beam transmitted through the polarized beam splitter 505 is incident on a spatial light modulator 508 via a polarized beam splitter 507. Signal beam 506 to which information is added by the spatial light modulator 508 is reflected from the polarized beam splitter 507 and propagates through an angle filter 509 that passes only the light beam with a predetermined incident angle. Thereafter, the signal beam is condensed to a hologram recording medium 1 by an object lens 510.

On the other hand, the light beam reflected from the polarized beam splitter 505 works as reference beam 512. After a predetermined polarization direction is set according to the time of recording or the time of reproducing by a polarization direction conversion element 519, the light beam is incident on a lens 515 via mirrors 513 and 514. The lens 515 serves to condense the reference beam 512 to the back focus surface of the object lens 510. The reference beam condensed once on the back focus surface of the object lens 510 is returned to parallel light again by the object lens 510 and is incident on the hologram recording medium 1.

Here, the object lens 510 or an optical block 521 can be driven, for example, in a direction indicated by reference numeral 520. By shifting the position of the object lens 510 or the optical block 521 in the driving direction 520, a relative positional relation between the object lens 510 and a condensing point on the back focus surface of the object lens 510 is changed. Therefore, an incident angle of the reference beam incident on the hologram recording medium 1 can be set to a desired angle. The incident angle of the reference beam may be set to the desired angle by driving the mirror 514 using an actuator instead of driving the object lens 510 or the optical block 521.

In this way, by causing the signal beam and the reference beam to be incident on the hologram recording medium 1 so that the signal beam and the reference beam are superimposed, an interference pattern is formed inside the recording medium and information is recorded by writing this pattern on the recording medium. Since the incident angle of the reference beam incident on the hologram recording medium 1 can be changed by shifting the position of the object lens 510 or the optical block 521 along the driving direction 520, recording can be performed through angle multiplexing.

When the recorded information is reproduced, as described above, the reproduction reference beam is generated by causing the reference beam to be incident on the hologram recording medium 1 and reflecting the light beam transmitted through the hologram recording medium 1 from the galvanometer mirror 516. Reproduced light reproduced from the reproduction reference beam propagates through the object lens 510 and the angle filter 509. Thereafter, the reproduced light is transmitted through the polarized beam splitter 507 and is incident on a light detector 518 so that the recorded signal can be reproduced.

Since the optical system illustrated in FIG. 5 is configured such that the signal beam and the reference beam are incident on the same object lens, there is the advantageous effect of considerably miniaturizing the optical system compared to the optical system structure illustrated in FIG. 3.

FIG. 6 is a diagram illustrating an operation flow of recording and reproducing in the optical information recording and reproducing device 10. Here, the flow of recording and producing performed particularly using holography will be described.

FIG. 6(a) is a diagram illustrating an operation flow until the optical information recording medium 1 is inserted into the optical information recording and reproducing device 10, and then preparation for recording and reproducing is completed. FIG. 6(b) is a diagram illustrating an operation flow until information is recorded on the optical information recording medium 1 from the preparation completion state. FIG. 6(c) is a diagram illustrating an operation flow until the information recorded on the optical information recording medium 1 is reproduced from the preparation completion state.

As illustrated in FIG. 6 (a), when the medium is inserted (601), for example, the optical information recording and reproducing device 10 performs disc determination to determine whether the inserted medium is a medium used to record or reproduce digital information using holography (602).

When the medium is determined to be the optical information recording medium used to record or reproduce the digital information using the holography as the result of the disc determination, the optical information recording and reproducing device 10 reads control data installed on the optical information recording medium (603) and acquires, for example, information regarding the optical information recording medium or, for example, information regarding various setting conditions at the time of recording or the time of reproducing.

After the control data is read, a learning process related to the pickup 11 or various kinds of adjustment according to the control data is performed (604). Then, the optical information recording and reproducing device 10 completes preparation for the recording or reproducing (605).

In the operation flow until the information is recorded from the preparation completion state, as illustrated in FIG. 6(b), data to be recorded is first received (611) and information according to the data is sent to the spatial light modulator in the pickup 11.

Thereafter, for example, various learning processes for the recording, such as power optimization of the light source 301 or exposure time optimization by the shutter 303, are performed in advance (612), as necessary, so that information with high quality can be recorded on the optical information recording medium.

Thereafter, in a seek operation (613), the access control circuit 81 is controlled such that the positions of the pickup 11 and the cure optical system 13 are located to predetermined positions on the optical information recording medium. When the optical information recording medium 1 has address information, the address information is reproduced and it is confirmed whether the positions are located to target positions. When the positions are not located to the target positions, deviation amounts from predetermined positions are calculated and the locating operation is repeated again.

Thereafter, the predetermined positions are pre-cured using the light beam emitted from the cure optical system 13 (614) and the data is recorded using the reference beam and the signal beam emitted from the pickup 11 (615).

After the data is recorded, post-curing is performed using the light beam emitted from the cure optical system 13 (616). The data may be verified, as necessary.

In the operation flow until the recorded information is reproduced from the preparation completion state, as illustrated in FIG. 6(c), the access control circuit 81 is first controlled in a seek operation (621) and the positions of the pickup 11 and the reproduction reference beam optical system 12 are located to predetermined positions on the optical information recording medium. When the optical information recording medium 1 has address information, the address information is reproduced and it is confirmed whether the positions are located to target positions. When the positions are not located to the target positions, deviation amounts from predetermined positions are calculated and the locating operation is repeated again.

Thereafter, the reference beam is emitted from the pickup 11, the information recorded on the optical information recording medium is read (622), and the reproduced data is transmitted (613).

FIG. 9 is a diagram illustrating a data processing flow at the time of recording and reproducing. FIG. 9(a) is a diagram illustrating a recorded data processing flow of the signal generation circuit 86 until the recorded data is received in the input and output control circuit 90 (611) and then the recorded data is converted into 2-dimensional data on the spatial light modulator 312. FIG. 9(b) is a diagram illustrating a reproduced data processing flow of the signal processing circuit 85 up to the transmission 624 of the reproduced data in the input and output control circuit 90 after the 2-dimensional data is detected with the light detector 325.

Data processing at the time of recording will be described with reference to FIG. 9(a). When user data is received (901), each data string is subjected to CRC (Cyclic Redundancy Check) so that splitting into a plurality of data strings and error detection at the time of reproducing can be performed (902). The number of on-pixels is substantially equalized with the number of off-pixels and scrambling of adding a pseudo-random number data string to a data string is performed in order to prevent repetition of the same pattern (903). Thereafter, error correction coding such as Reed-Solomon code is performed so that error correction at the time of reproducing is performed (904). Next, 2-dimensional data corresponding to one page is configured by converting the data string into M×N 2-dimensional data and repeating this action corresponding to one page data (905). A marker serving as a criterion of image position detection at the time of reproducing or image distortion correction on the 2-dimensional data configured in this way is added (906) and the data is transmitted to the spatial light modulator 312 (907).

Next, a data processing flow at the time of reproducing will be described with reference to FIG. 9(b). Image data detected by the light detector 325 is transmitted to the signal processing circuit 85 (911). The image position is detected based on the marker included in the image data (912) and deformation such as inclination, magnification, distortion of an image is corrected (913). Thereafter, a binarization process is performed (914) and the marker is removed (915) so that 2-dimensional data corresponding to one page is acquired (916). After the 2-dimensional data obtained in this way is converted into a plurality of data strings, an error correction process is performed (917) to remove a parity data string. Next, a scrambling releasing process is performed (918), an error detection process is performed using the CRC (919), and the CRC parity is deleted. Thereafter, the user data is transmitted via the input and output control circuit 90 (920).

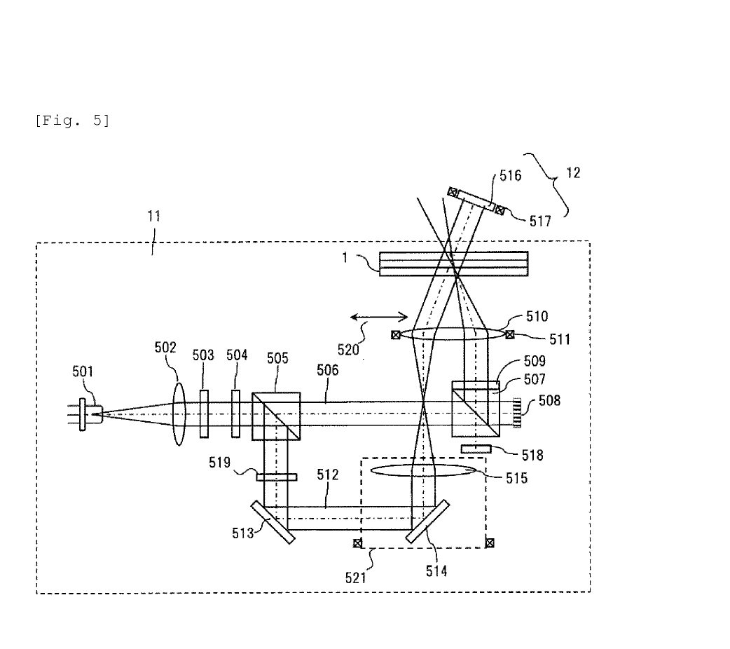

FIG. 7 is a block diagram illustrating the signal generation circuit 86 of the optical information recording and reproducing device 10.

When an input of the user data into the output control circuit 90 starts, the input and output control circuit 90 notifies the controller 89 that the input of the user data starts. The controller 89 receives this notification and commands the signal generation circuit 86 to perform a process of recording data corresponding to one page input from the input and output control circuit 90. A sub-controller 701 in the signal generation circuit 86 is notified of a process command from the controller 89 via a control line 708. The sub-controller 701 receiving this notification performs control of each signal processing circuit via the control line 708 such that each signal processing circuit operates in parallel. First, the sub-controller 701 performs control such that the memory control circuit 703 stores the user data input from the input and output control circuit 90 via a data line 709 in a memory 702. When the user data stored in the memory 702 reaches a certain amount, the sub-controller 701 performs control such that a CRC arithmetic circuit 704 performs CRC on the user data. Next, the sub-controller 701 performs control such that a scrambling circuit 705 performs scrambling on the data subjected to the CRC to add the pseudo-random data string and an error correction coding circuit 706 performs error correction coding to add the parity data string. Finally, a pickup interface circuit 707 is caused to read the data subjected to the error correction coding from the memory 702 in row order of the 2-dimensional data on the spatial light modulator 312, the marker serving as a criterion at the time of reproducing is added, and then the 2-dimensional data is transmitted to the spatial light modulator 312 in the pickup 11.

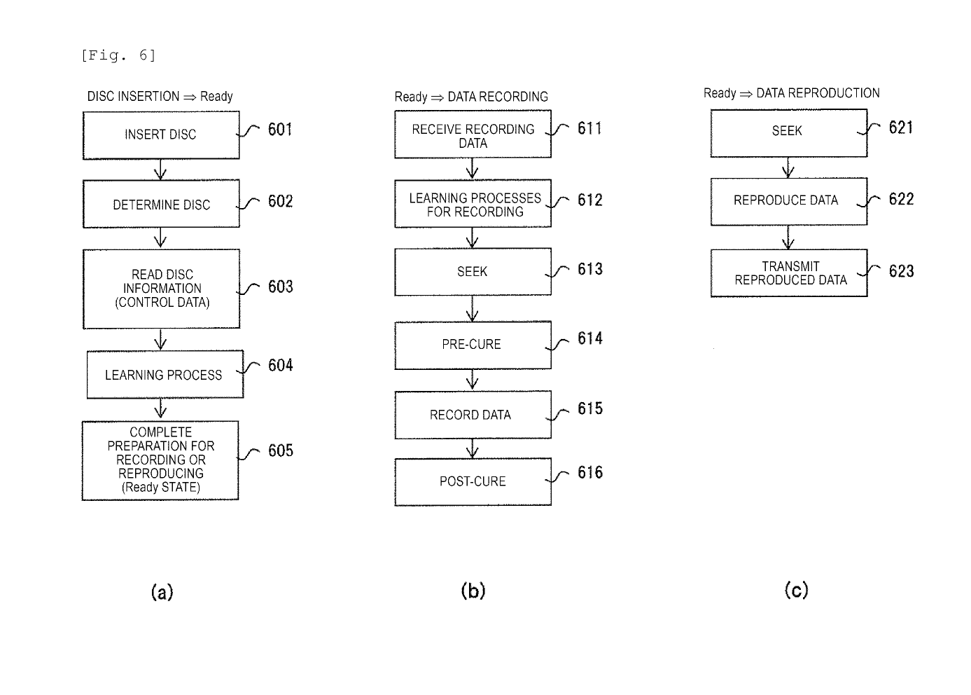

FIG. 8 is a block diagram illustrating the signal processing circuit 85 of the optical information recording and reproducing device 10.

When the light detector 325 in the pickup 11 detects the image data, the controller 89 commands the signal processing circuit 85 to perform a process of reproducing data corresponding to one page input from the pickup 11. A sub-controller 801 in the signal processing circuit 85 is notified of a process command from the controller 89 via a control line 811. The sub-controller 801 receiving this notification performs control of each signal processing circuit via the control line 811 such that each signal processing circuit operates in parallel. First, the sub-controller 801 performs control such that the memory control circuit 803 stores the image data input from the pickup 11 via a pickup interface circuit 810 in a memory 802 via the data line 812. When the data stored in the memory 802 reaches a certain amount, the sub-controller 801 performs control such that an image position detection circuit 809 detects the marker from the inside of the image data stored in the memory 802 and extracts an effective data range. Next, the sub-controller 801 performs control such that an image deformation correction circuit 808 performs deformation correction such as inclination, magnification, or distortion of an image using the detected marker and converts the size of the image data into the size of expected 2-dimensional data. The sub-controller 801 performs control such that a binarization circuit 807 binarizes each piece of bit data of a plurality of bits included in the 2-dimensional data subjected to the size conversion to determine “0” and “1” and stores the data in the rows of the output of the reproduced data on the memory 802. Next, the sub-controller 801 performs control such that an error correction circuit 806 corrects an error contained in each data string, a scrambling releasing circuit 805 releases the scrambling of adding the pseudo-random data string, and a CRC arithmetic circuit 804 confirms that an error is not contained in the user data on the memory 802. Thereafter, the user data is transmitted from the memory 802 to the input and output control circuit 90.

Here, a method of performing the positioning to a recorded target hologram (book) accurately in the optical information recording and reproducing device according to the embodiment described above will be described.

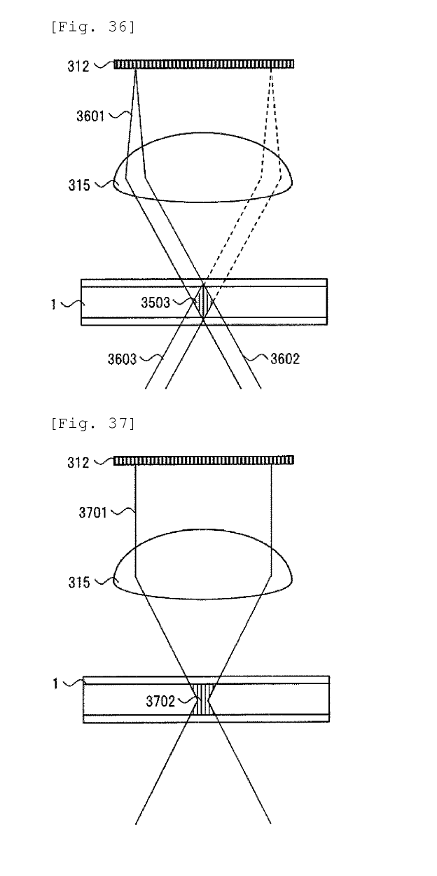

First, a principle of the scheme will be described with reference to FIGS. 35 to 38. FIGS. 35 to 38 are diagrams illustrating essential portions extracted in the optical system in FIG. 3. An interference fringe of the signal beam and the reference beam is recorded in the hologram recorded in the optical system in FIG. 3. Further, as illustrated in FIG. 35, signal beam 3501 and signal beam 3502 from respective pixels of the spatial light modulator 312 intersect in the optical information recording medium 1, so that an interference fringe is formed and recorded as a hologram 3503. Accordingly, as illustrated in FIG. 36, when detection light 3601 which is a part of the recorded signal beam is exposed to the recorded hologram 3503, the recorded signal beam 3502 can be obtained as a diffracted beam 3603. Simultaneously, transmitted light 3602 is also generated.

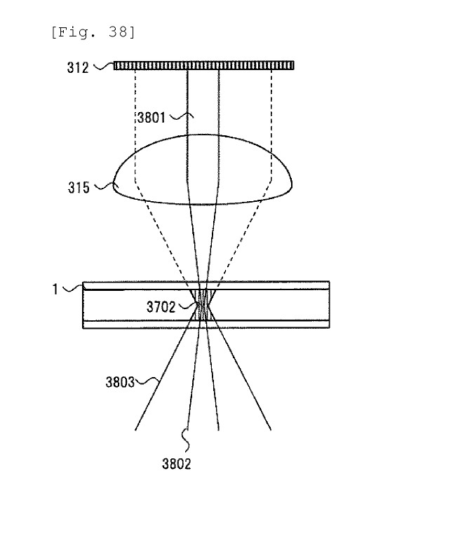

The example of two pixels has been described above, but numerous pixels are mutually interfered actually. This case will be described with reference to FIGS. 37 and 38. As illustrated in FIG. 37, signal beam 3701 from the spatial light modulator 312 is condensed in the optical information recording medium 1, so that an interference fringe is formed and recorded as a hologram 3702. Accordingly, as illustrated in FIG. 38, when detection light 3801 which is apart of the recorded signal beam is exposed to the recorded hologram 3702, the recorded signal beam 3701 can be obtained as a diffracted beam 3803. Since this diffracted beam is generated from the recorded hologram, the locating of high precision is possible by adjusting the position of the optical information recording medium 1 and/or the pickup 11 based on the diffracted beam. Simultaneously, transmitted light 3802 is also generated. However, the light amount of transmitted light 3802 is larger than that of the diffracted beam 3803. Therefore, when the transmitted light 3802 is blocked, a signal of only the diffracted beam can be generated, and thus position detection accuracy can be improved. Further, since the recorded hologram is also subjected to angle multiplexing, characteristics are obtained in which the obtained diffracted beam is superimposed on the diffracted beam from all of the pages and the light amount of diffracted beam also increases.

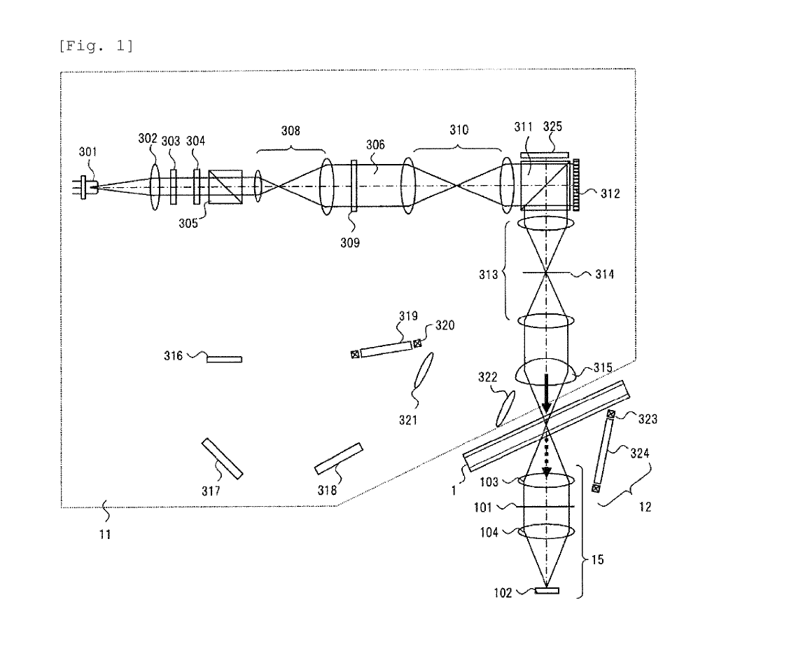

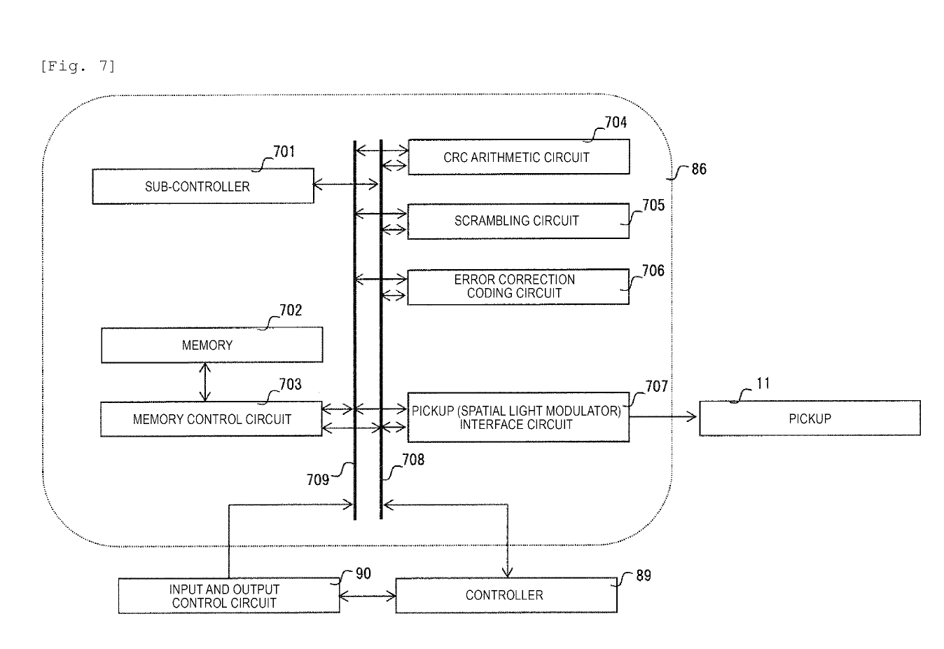

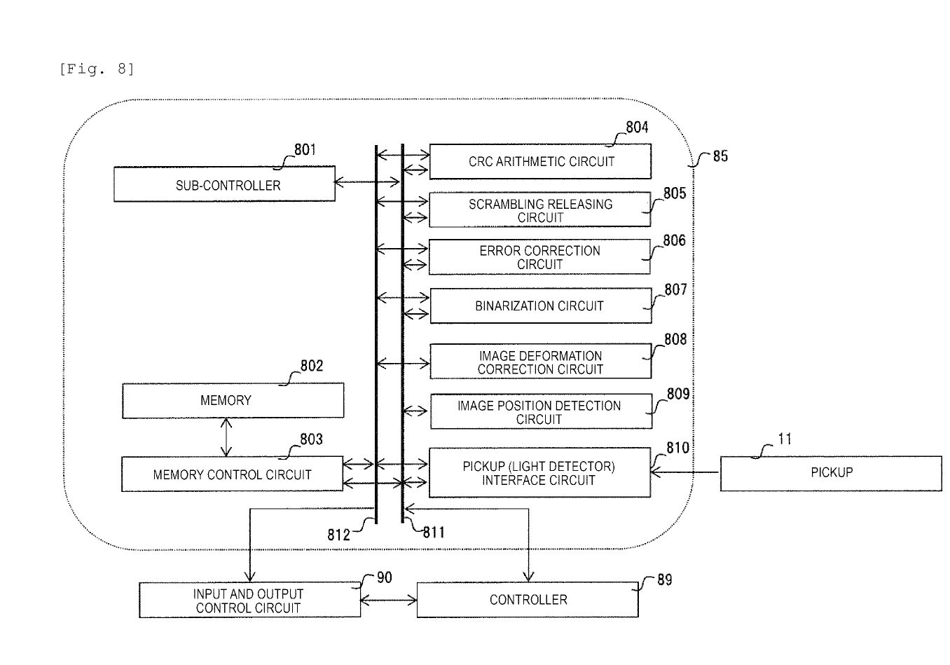

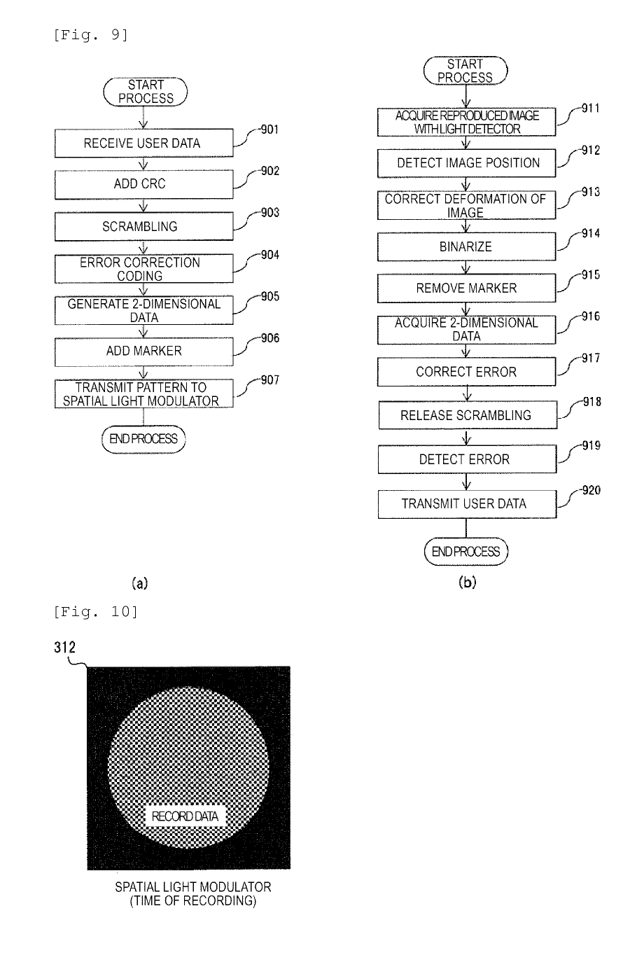

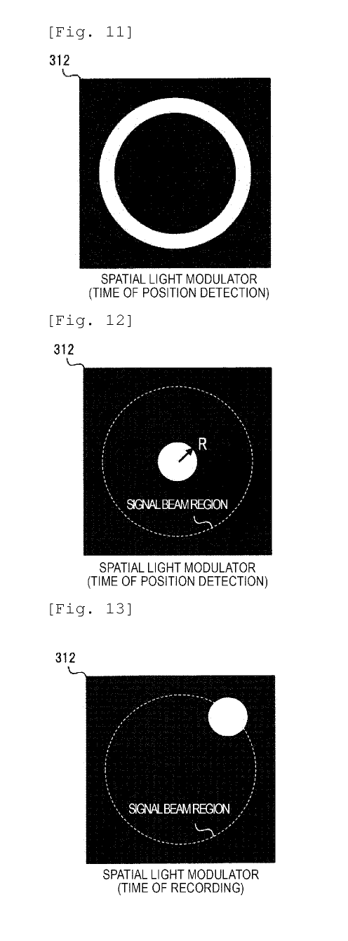

Next, a case in which this principle is applied to an actual recording and reproducing device will be described. FIG. 1 is a diagram illustrating an example in which a position detection optical system 15 is added to the recording and reproducing device in FIG. 2 so that position control to a target hologram (book) is possible at the time of reproducing. After the light beam diameter of a light beam emitted from the light source 301 and transmitted through the PBS prism 305 is expanded by the beam expander 308, the light beam is transmitted through the phase mask 309, the relay lens 310, and the PBS prism 311 and is incident on the spatial light modulator 312. When the phase mask 309 is present, the phases at the time of recording and the time of detection may be deviated and a diffracted beam may not be obtained well in some cases. Therefore, at the time of position detection, the light beam may not be transmitted through the phase mask 309. In the spatial light modulator 312, recording data illustrated in FIG. 10 is displayed at the time of recording. However, at the time of position detection, an image illustrated in FIG. 11 or 12 is displayed in the spatial light modulator 312. In FIGS. 11 and 12, white indicates that light is transmitted and black indicates that light is not transmitted. This transmission region (the region indicated by white) may include a part of a signal beam region (a region indicated by a dotted line) or may be a pattern illustrated in FIG. 13. In this case, for example, when detection light is generated from another light source, it is not necessary to put the transmission region inside the signal beam region. Therefore, there is an advantageous effect in which design is easy. The shape of the transmission region may be not only circular but also rectangular. In this case, for example, there is an advantageous effect in which design of a mask 101 to be described later is easy. Detection light for position detection generated by the spatial light modulator 312 is reflected from the PBS prism 311 and propagates through the relay lens 313 and the spatial filter 314. Thereafter, the detection light is condensed to the optical information recording medium 1 by the object lens 315. Diffracted light diffracted by the detection light propagates through relay lenses 103 and 104 and the mask 101 and is incident on a light detector 102. As described above, since the diffracted beam includes the detection light (0th-order diffracted beam) transmitted through the optical information recording medium 1, the diffracted beam is blocked by the mask 101. In the case of the detection light used in FIG. 11, the mask 101 uses a pattern in FIG. 14. In the case of the detection light in FIG. 12, the mask 101 uses a pattern in FIG. 15. In FIGS. 14 and 15, white indicates that light is transmitted and black indicates that light is not transmitted. The non-transmission region can be created by disposing a material, such as metal or paint, through which light is not transmitted on a transparent plate. When the non-transmission region is disposed so that a distance between the optical information recording medium 1 and the relay lens 103 and a distance between the relay lens 103 and the mask 101 are a focal distance of the relay lens 103, an image of the spatial light modulator 312 appears in the mask 101. Therefore, masking is easy, but the invention is not limited thereto. The pattern of the mask 101 is preferably set to be slightly larger so that the pattern includes a pattern displayed in the spatial light modulator 312 in consideration of position deviation of the optical information recording medium 1 or the mask, aberration, and the like. The pattern of the mask can also be varied, for example, by combining a liquid crystal element and a polarization plate and changing a pattern displayed in the liquid crystal element.

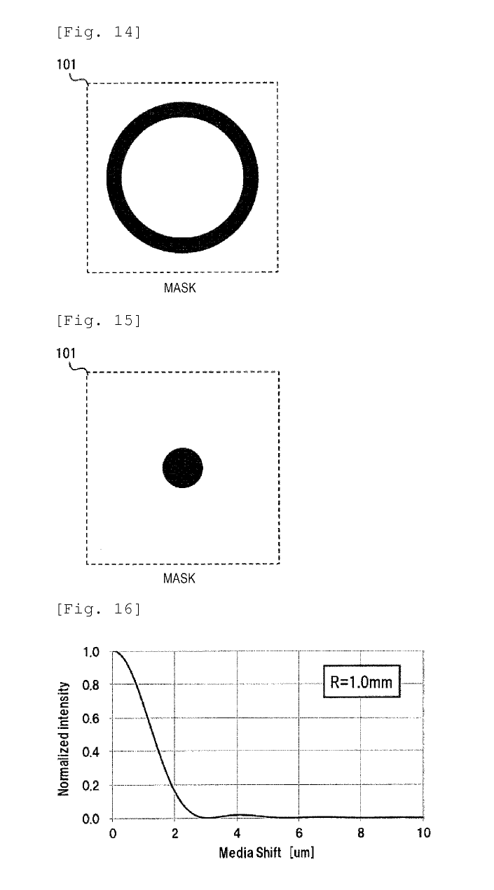

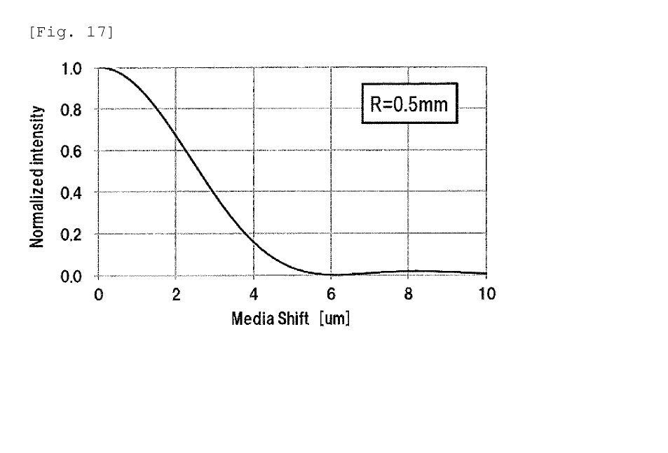

Here, a pattern and a position detection sensitivity of the spatial light modulator 312 will be described. In FIGS. 16 and 17, graphs indicating diffraction efficiency in a movement amount of the optical information recording medium are illustrated. The horizontal axis represents a movement amount (shift at the time of recording and the time of position detection) of the optical information recording medium 1. The vertical axis represents a diffracted beam intensity. The pattern of the spatial light modulator 312 is a result obtained by changing a radius R of the transmission region at the time of FIG. 12. From this result, it can be understood that sensitivity is low when the transmission region is small (R=0.5 mm) and sensitivity is high when the transmission region is large (R=1.0 mm). Thus, the pattern of the spatial light modulator 312 can be decided in consideration of a necessary detection range and sensitivity. In the embodiment, the detection light has been generated by causing a part of the laser light from the laser light source that also generates the reference beam as the detection light to detect the position deviation to be incident from a light path of the signal beam at the time of recording, but the invention is not necessarily limited thereto. For example, the laser light source generating the detection light may be a separate light source from the laser light source generating the reference beam. That is, light may be incident to the optical information recording medium in an incident direction (which may be a partial incident direction) of the signal beam at the time of recording on the recording medium. In the embodiment, a configuration generating light serving as the function is referred to as a detection light generation unit. Further, a configuration guiding the detection light to the optical information recording medium is referred to as a detection light incident unit.

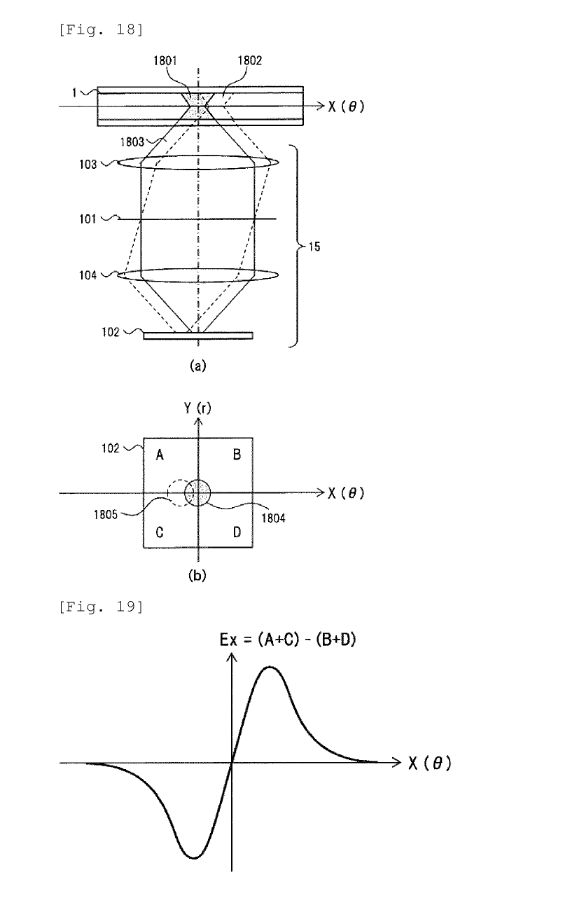

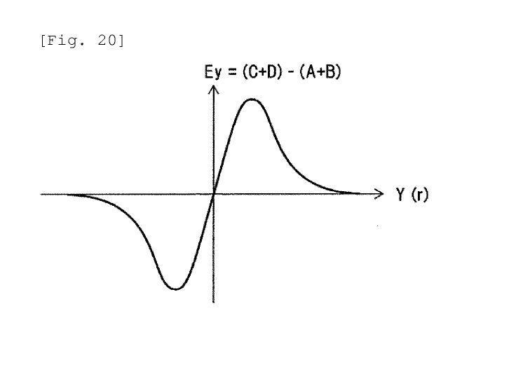

Next, a method of generating the position detection signal will be described. In FIG. 18, the details of the optical information recording medium 1 and the position detection optical system 15 are illustrated. To facilitate the description, the angle of the optical information recording medium 1 is changed as in FIG. 1, but the same application is possible in consideration of an inclination even when the optical information recording medium is inclined. Diffracted light 1803 from a recorded hologram 1801 is incident on the light detector 102 (see FIG. 18(a)). The top view of the light detector 102 is FIG. 18(b). The light detector 102 is divided into four regions and a position detection signal is generated in accordance with the positions of light spots 1804 and 1805 of the diffracted beam. For example, a position detection signal Ex in an X direction (a rotational direction θ of the optical information recording medium 1) of FIG. 18 is generated by calculating luminances of the divided regions A, B, C, and D of the light detector 102 with Ex=(A+C)−(B+D). In FIG. 19, a change in the position detection signal Ex with respect to the X direction is illustrated. For example, when the hologram is located at a position 1801, the light spot 1804 is obtained, and thus Ex=0. When the hologram is located at a position 1802, the light spot 1805 is obtained, and thus Ex>0. The optical information recording medium 1 and/or the pickup 11 may be controlled such that the position detection signal Ex becomes 0. Similarly, a position detection signal Ey in a Y direction (a radial direction r of the optical information recording medium 1) of FIG. 18 is generated through calculation with Ey=(C+D)−(A+B). In FIG. 20, a change in the position detection signal Ey with respect to the Y direction is illustrated. The optical information recording medium 1 and/or the pickup 11 may be controlled such that the position detection signal Ey becomes 0. When the position detection signals Ex and Ey are small, standardization with the luminance of (A+B+C+D) is also effective. Control may be performed such that the position detection signal is set with (A+B+C+D) and the position detection signal is maximized. A control target of the pickup 11 may be all of the constituent elements of the pickup 11 or some of the constituent elements such as the spatial filter 314 and the object lens 315. The definitions of the X, Y, θ, and r described here are not limited and can similarly be applied irrespective of the shape of the disc such as a discoid disc and a quadrate shape.

Next, a position control procedure in which the above-described configuration is used will be described. In FIG. 21, a processing flow at the time of reproducing is illustrated. When a target book is reproduced, the pattern of FIG. 12 is displayed in the spatial light modulator 312 (2101) and the optical element 304 controls the polarization direction so that the detection light is generated (2102). Next, the positioning is performed near a target book position (2103), the detection light is exposed to the optical information recording medium 1 and the rotational angle is controlled so that the position detection signal Ex becomes 0 (2104). Continuously, the radius position is controlled such that the position detection signal Ey becomes 0 (2105). Next, the polarization direction is controlled by the optical element 304 such that the reference beam for reading data is generated (2106). The generated reference beam is exposed to the optical information recording medium 1 to read information regarding the book (2107). The operations from 2102 to 2107 are repeated until the reproduction is completed (2108). Each book position is adjusted in the foregoing example, but a high speed can be achieved by performing steps 2102, 2104, and 2105 for every several books. The pattern displayed in the spatial light modulator 312 has been described with reference to FIG. 12, but the invention is not limited thereto. Any pattern may be used as long as the detection light is light including a part of the signal beam at the time of recording. The procedure of steps 2104 and 2105 may be reversed.

According to the foregoing first embodiment, the signal of the light detector of which a response speed is fast can be used generally. Further, the position control method at high speed and high accuracy is possible by controlling a position at which the detection signal is 0 to a target.

In the foregoing configuration, the spatial light modulator 312 is used to generate the detection light including a part of the recorded signal beam, but the invention is not limited thereto. A separate optical system for detection may be provided. For example, by decreasing the light beam diameter by the beam expander 308, the light blocked by the spatial light modulator 312 is decreased, thereby improving efficiency. The same also applies to subsequent embodiments.

### Second Embodiment

Differences between this embodiment and the first embodiment are a position control procedure and a display pattern of the spatial light modulator 312. As described above, the position detection range and the sensitivity can be set arbitrarily by changing the pattern of the spatial light modulator 312. However, when the position detection range is considerably taken, the sensitivity near an adjustment target may become low. From this viewpoint, in the embodiment, the position detection range and the sensitivity can be compatible with each other by performing control to switch a first position detection image in which the radius of the transmission region in FIG. 12 is small so that the position detection range increases and a second position detection image in which the radius of the transmission region in FIG. 12 is larger than that of the first position detection image so that the sensitivity increases near a target.

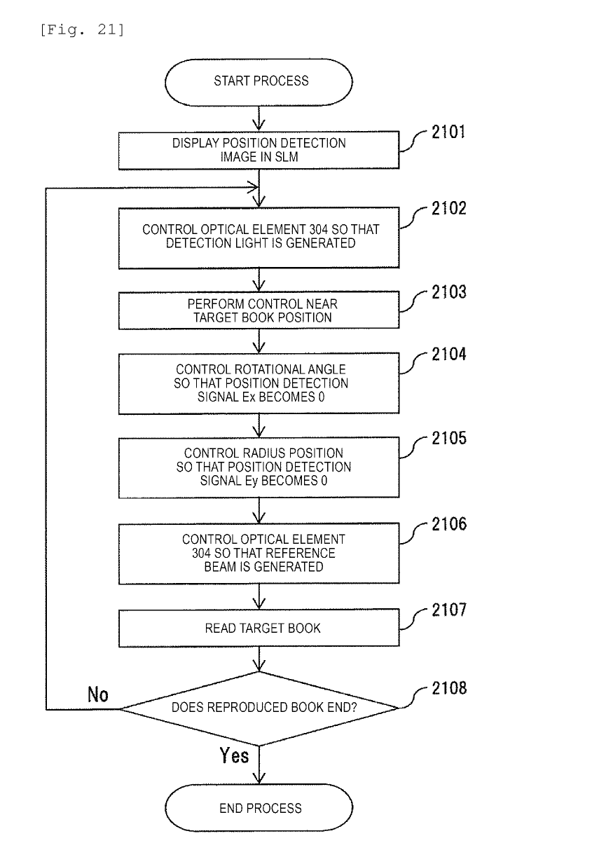

The position control procedure according to the embodiment will be described with reference to the processing flow of FIG. 22. When a target book is reproduced, the first position detection image in which the radius in FIG. 12 is small is displayed in the spatial light modulator 312 (2201) and the polarization direction is controlled by the optical element 304 so that the detection light is generated (2102). Next, the positioning is performed near a target book position (2103), the detection light is exposed to the optical information recording medium 1 and the rotational angle is controlled so that the position detection signal Ex becomes 0 (2104). Continuously, the radius position is controlled such that the position detection signal Ey becomes 0 (2105). Next, the second position detection image in which the radius in FIG. 12 is large is displayed in the spatial light modulator 312 (2202) and the rotation angle is controlled such that the position detection signal Ex becomes 0 (2203). Continuously, the radius position is controlled such that the position detection signal Ey becomes 0 (2304). The subsequent operations are the same as those of the first embodiment and the operations from 2201 to 2107 are repeated until the reproduction is completed (2108). Each book position is adjusted in the foregoing example, but steps 2201, 2104, and 2105 may be performed every several books. The pattern displayed in the spatial light modulator 312 has been described with reference to FIG. 12, but the invention is not limited thereto. Any pattern may be used as long as the shapes of the first position detection image and the second position detection image are changed. The procedure of steps 2104 and 2105 and of steps 2203 and 2204 may be reversed.

According to the foregoing second embodiment, the position control at high speed and high accuracy in which the position detection range and the sensitivity are compatible is possible by changing the size of the detection light.

### Third Embodiment

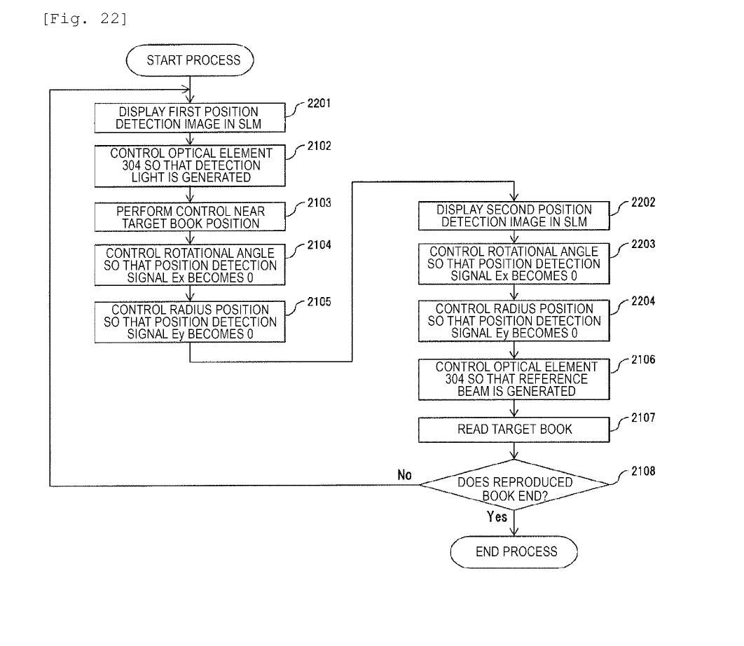

Next, another embodiment of the detection light generation unit and the detection light incident unit will be introduced. A difference between this embodiment and the first embodiment is a position control procedure. In general, it takes some time to change the polarization direction of the optical element 304 as in the processing flow of FIG. 21 in the first embodiment. Accordingly, this problem does not occur when the polarization direction of the optical element 304 is controlled so that both of the detection light and the reference beam are normally generated as in FIG. 23. Differences between FIG. 23 and FIG. 4 which is a diagram of the configuration at the time of reproducing are that the position detection optical system 15 and a shutter 2301 are disposed and light is transmitted even on the signal beam side at the time of reproducing.

The position control procedure according to the embodiment will be described with reference to the processing flow of FIG. 24. When a target book is reproduced, the pattern of FIG. 12 is displayed in the spatial light modulator 312 (2101) and the polarization direction is controlled by the optical element 304 so that the detection light and the reference beam are generated (2401). The subsequent operations are the same as those of the first embodiment and the operations from 2103 to 2107 are repeated until the reproduction is completed (2108). A light amount ratio between the detection light and the reference beam in step 2401 is preferably set to “detection light:reference beam=1:9” in that the quality of a reproduced image deteriorates when the light amount of reference beam is lowered, but the invention is not limited thereto. Further, noise occurs in some cases when the reference beam is exposed at the time of position detection. In order to suppress the noise, it is effective to dispose the shutter 2301 in a path of the reference beam and block the reference beam at the time of position detection. This shutter may be disposed at any position as long as a path is a path along which the reference beam is exposed to the optical information recording medium 1. The procedure of steps 2104 and 2105 may be reversed.

According to the foregoing third embodiment, a time taken to control the optical element 304 is not necessary. Therefore, the position control at high speed and high accuracy is possible.

### Fourth Embodiment

Differences between this embodiment and the first embodiment are the position detection optical system 15 and the hologram position detection method. When it is difficult to perform the control near the target book position as in step 2103 of FIG. 21 in the first embodiment, there is a risk of an error occurring in an adjacent book. Accordingly, this problem does not occur when a page capable of searching a target book is recorded.

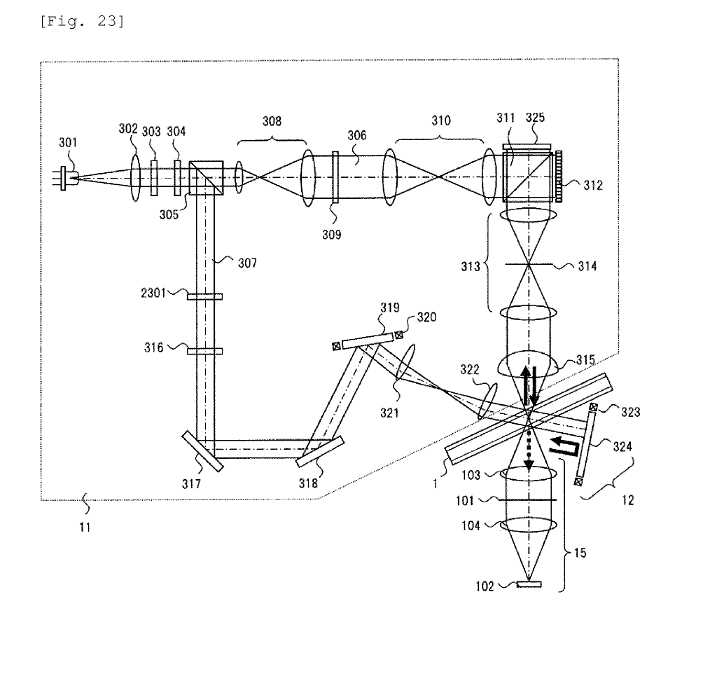

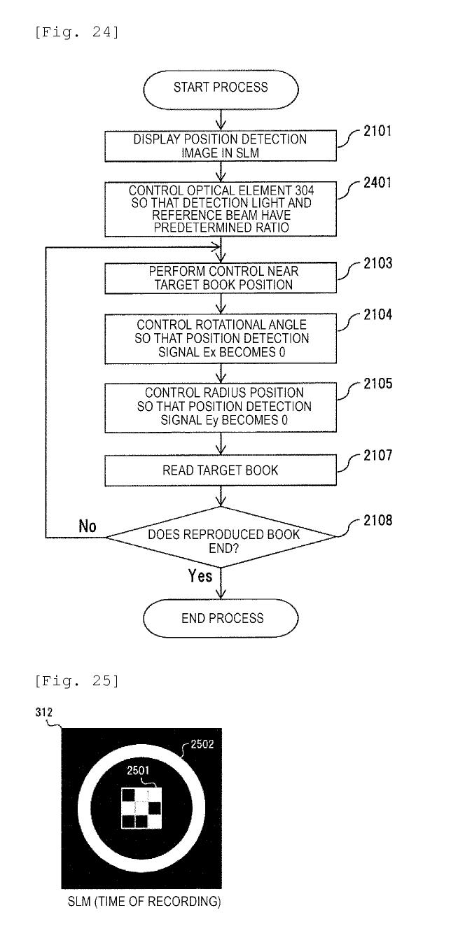

In FIG. 25, a book search page according to the embodiment is illustrated. An address pattern 2501 unique to the book or different from an adjacent book is disposed in the center and a reference pattern 2502 which is circular is disposed around the address pattern 2501. Associating the address pattern 2501 with the address of the book is a simple method. However, to avoid error detection, it is preferable to set a pattern with low correlation with the adjacent book or a close book. The reference pattern is not limited to the reference pattern 2502. To broad the detection range, the reference pattern may be a small region with respect to the region of the signal beam.

At the time of position detection, the detection light is generated by displaying the address pattern 2501 of a target book in the spatial light modulator 312. Thus, the strong diffracted beam can be obtained only when the detection light is exposed to the hologram of the target book. The mask 101 at this time blocks a region including the address pattern 2501 as in FIG. 27.

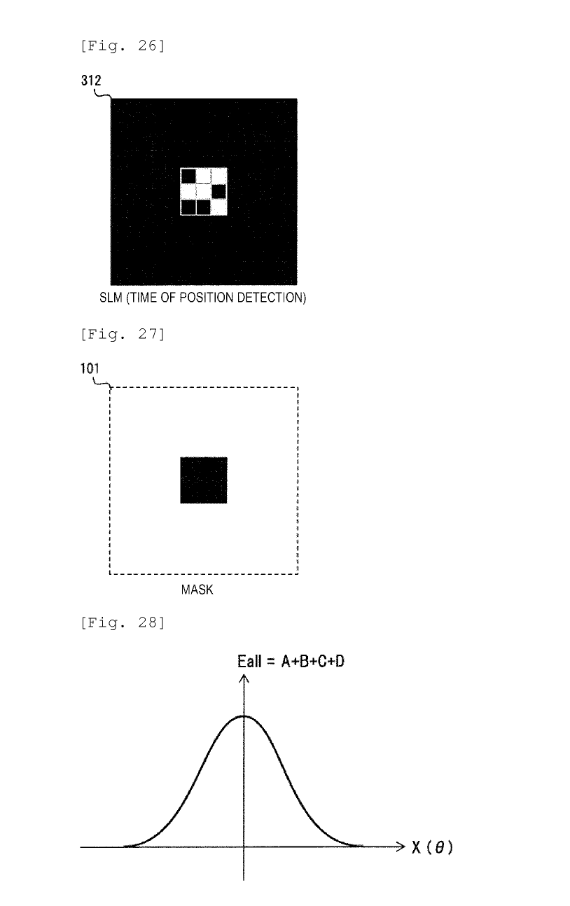

A position detection signal Eall for book search is generated by calculating the luminances of the divided regions A, B, C, and D of the light detector 102 with Eall=(A+B+C+D). In FIG. 28, a change in the position detection signal Eall in the X direction is illustrated. Since Eall is maximized at the center of a target book position, the optical information recording medium 1 and/or the pickup 11 may be controlled so that the position detection signal Eall is maximized.

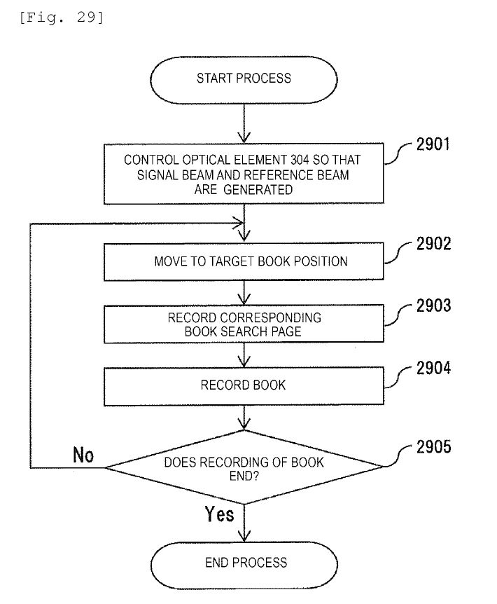

Next, a book search page recording procedure using the above-described configuration will be described. In FIG. 29, the processing flow is illustrated. First, the polarization direction is controlled by the optical element 304 so that the signal beam and the reference beam are generated (2901). Next, the positioning is performed at the target book position (2902), the book search page with the address pattern of the target book is displayed in the spatial light modulator 312, and the signal beam is exposed to the optical information recording medium 1 to perform recording (2903). Continuously, a normal page is subjected to angle multiple recording while changing a reference beam angle (2904). The operations from 2902 to 2904 are repeated until the recording is completed (2905). The book search page is recorded for each book in the foregoing example, but high speed can be achieved by performing step 2903 for every several books.

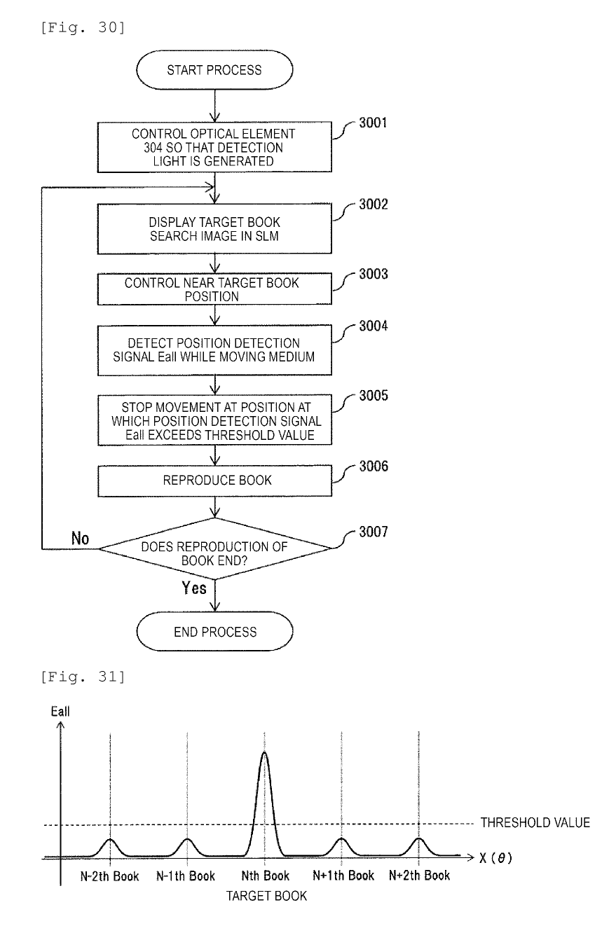

Next, the position control procedure using the above-described configuration will be described. In FIG. 30, the processing flow is illustrated. When the target book is reproduced, the polarization direction is controlled by the optical element 304 so that the detection light is generated (3001) and the address pattern of the target book is displayed in the spatial light modulator 312 (3002). Next, the positioning is performed near the target book position (3003), the detection light is exposed to the optical information recording medium 1, and the position detection signal Eall is detected while moving the optical information recording medium 1 (3004). Here, for example, when the optical information recording medium 1 is moved in the X direction as in FIG. 31, the position detection signal Eall increases at the target book position. The position detection signal Eall is not 0 at another book position since parts of the address pattern match, but the position detection signal Eall is smaller than the position detection signal Eall at the target book position. Accordingly, a threshold value is decided in advance. When the position detection signal is greater than the threshold value, the book position is determined to be the target book position and the movement of the optical information recording medium 1 is stopped (3005). Thereafter, the book is reproduced according to the method of the first embodiment or the like (3006). The operations from 3002 to 3006 are repeated until the reproduction is completed (3007). Each book is searched in the foregoing example, but a high speed can be achieved by performing steps 3002 to 3005 for only the first read book or for several books. Further, steps 3004 and 3005 have been described when the optical information recording medium 1 is moved, but the pickup 11 may be moved.

According to the foregoing fourth embodiment, the target book can be searched at a high speed, and thus the position control at high speed and high accuracy is possible without performing the control erroneously in the adjacent book.

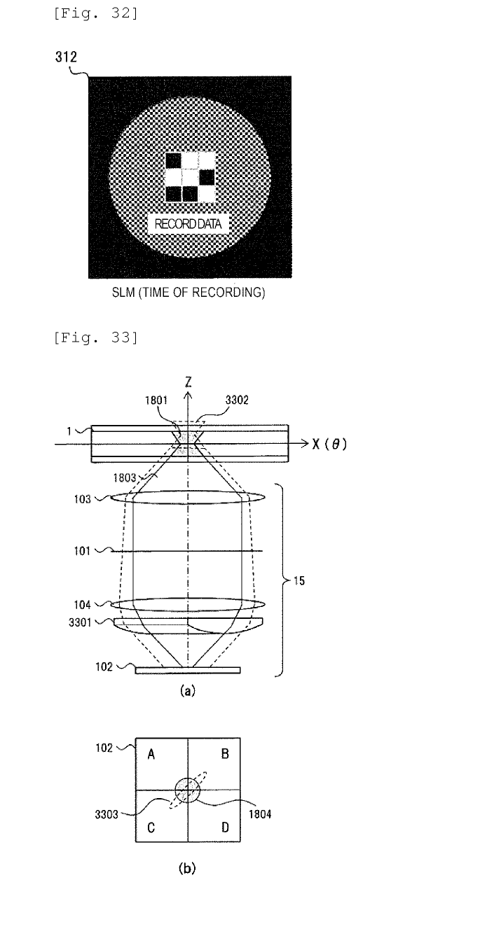

In the foregoing description, the example in which the book search page is recorded as in FIG. 25 has been described. However, when the address pattern 2501 is embedded in a normal page as in FIG. 32, it is not necessary to record the book search page. Since sufficient diffracted beam may not be obtained merely by recording a single book search page, it is effective to create a search book for which the book search page is recorded for a long exposure time for every several books. The position and the size of the address pattern are not limited to those of the address pattern 2501, but may be disposed at any position in the page. However, when the size is small, the detection range becomes broad. Therefore, the small size is preferable for the book search. When the phase mask 309 is present, a phase is deviated at the time of recording and the time of detection and the diffracted beam may not be obtained well in some cases. Therefore, when the book search page is recorded and/or reproduced, the light may not be transmitted through the phase mask 309.

### Fifth Embodiment

A difference between this embodiment and the first embodiment is the position detection optical system 15. In the first embodiment, the position control in the X and Y directions has been described. However, in the embodiment, position control in the Z direction (focus direction) is configured to be possible.

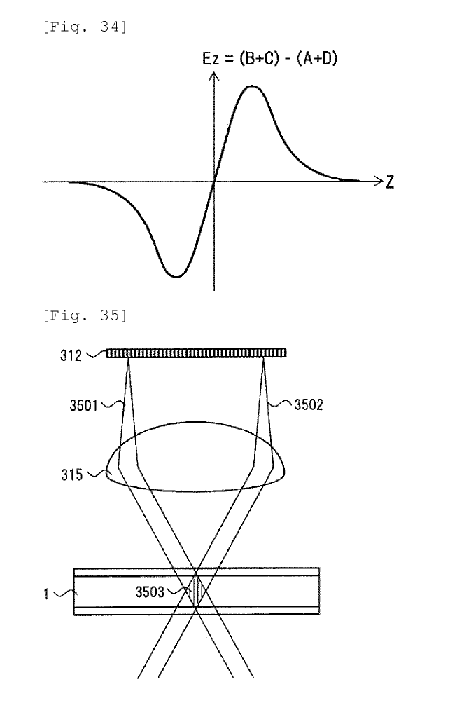

In FIG. 33, the details of the optical information recording medium 1 and the position detection optical system 15 are illustrated. A difference from FIG. 18 is a cylindrical lens 3301. The cylindrical lens is a lens that has a cylindrical refraction plane. The cylindrical lens 3301 is disposed to be inclined at 45° from the X axis so that the inclination of a cylindrical axis matches an inclination of a diagonal line of the light detector 102. Since a division direction can be configured to be common to the position detection in the X and Y directions by doing so, the efficiency is good. To facilitate the description, the angle of the optical information recording medium 1 is changed in FIG. 1. However, the optical information recording medium is inclined, the same applies by considering the inclination. The top view of the light detector 102 is FIG. 33 (b). The focal distances and the positions of the cylindrical lens 3301 and the relay lens 104 are decided so that the light spot 1804 of the diffracted beam becomes a precise circle. When the optical information recording medium 1 is moved in the Z direction in this situation, the light spot 3303 of the diffracted beam from the recorded hologram 3302 becomes an elliptical shape. Accordingly, a position detection signal Ez in the Z direction (the thickness direction of the optical information recording medium 1) is generated by calculating the luminances of the divided regions A, B, C, and D of the light detector 102 with Ez=(B+C)−(A+D). In FIG. 34, a change in the position detection signal Ez in the Z direction is illustrated. For example, when the hologram is located at a position 1801, the light spot 1804 is obtained, and thus Ez=0. When the hologram is located at a position 3302, the light spot 3303 is obtained, and thus Ez>0. The optical information recording medium 1 and/or the pickup 11 may be controlled such that the position detection signal Ex becomes 0.

According to the foregoing fifth embodiment, the position control at high speed and high accuracy is possible even in the Z direction (the focus direction)

In the foregoing configuration, the description has been made using the cylindrical lens. For example, when a mask in which a half region centering on the optical axis is set as a non-transmission region at the position of the cylindrical lens 3301 is disposed instead, cost can be reduced. Any mask may be used as long as a luminance distribution of the light spot of the light detector 102 is changed when the hologram is moved in the Z direction.

The invention is not limited to the foregoing embodiments, but includes various modifications. For example, the foregoing embodiments have been described in detail to facilitate the understanding of the invention. The invention is not limited to embodiments in which all of the above-described configurations are necessarily included. A part of the configuration of a certain embodiment may be substituted with the configuration of another embodiment and the configuration of another embodiment may also be added to the configuration of a certain embodiment. A part of the configuration of each embodiment can be added to, deleted from, replaced with another configuration.

Some or all of the foregoing configurations, functions, processing units, processing means, and the like may be realized with hardware, for example, by performing design with, for example, integrated circuits. Further, the foregoing configurations, functions, and the like may be realized with software by a processor analyzing and executing a program which realizes each function. Information regarding the program, tables, files, and the like realizing each function may be stored in a memory, a recording device such as a hard disk, a solid state drive (SSD), or a recording medium such as an IC card, an SD card, or a DVD.

The control lines or the information lines considered to be necessary for the description are denoted. All of the control lines or the information lines may not be denoted necessarily for products. In practice, most of all the configurations may be considered to be connected to each other.

### REFERENCE SIGNS LIST

1 optical information recording medium
10 optical information recording and reproducing device
11 pickup
12 reproduction reference beam optical system
13 disc cure optical system
14 disc rotational angle detection optical system
15 position detection optical system
50 rotational motor
81 access control circuit
82 light source driving circuit
83 servo signal generation circuit
84 servo control circuit
85 signal processing circuit
86 signal generation circuit
87 shutter control circuit
88 disc rotation motor control circuit
89 controller
90 input and output control circuit
91 external control device
101 mask
102 light detector
103 relay lens
104 relay lens
301 light source
302 collimating lens
303 shutter
304 half-wavelength plate
305 polarized beam splitter
306 signal beam
307 reference beam
308 beam expander
309 phase mask
310 relay lens
311 polarized beam splitter
312 spatial light modulator
313 relay lens
314 spatial filter
315 object lens
316 polarization direction conversion element
317 mirror
318 mirror
319 mirror
320 actuator
321 lens
322 lens
323 actuator
324 mirror
325 light detector
501 light source
502 collimating lens
503 shutter
504 optical element
505 polarized beam splitter
506 signal beam
507 polarized beam splitter
508 spatial light modulator
509 beam expander
510 relay lens
511 phase mask
512 relay lens
513 spatial filter
514 mirror
515 mirror
516 mirror
517 actuator
518 light detector
519 lens
520 lens
521 mirror
522 actuator
523 reference beam
524 polarization direction conversion element
525 object lens
1801 hologram
1802 hologram
1803 diffracted beam
1804 light spot
1805 light spot
2301 shutter
2501 address pattern
2502 reference pattern
3301 cylindrical lens
3302 hologram
3303 light spot
3501 signal beam
3502 signal beam
3503 hologram
3601 detection light
3602 transmitted light
3603 diffracted beam
3701 signal beam
3702 hologram
3801 detection light
3802 transmitted light
3803 diffracted beam

1. An optical information recording and reproducing device that records an interference fringe obtained by interfering reference beam and signal beam as a hologram on an optical information recording medium and reproduces information using the reference beam from the hologram recorded on the optical information recording medium, the optical information recording and reproducing device comprising:
a detection light generation unit that generates light including a part of the signal beam as detection light;
a detection light incident unit that causes the detection light to be incident on the recorded hologram; and
a light detection unit that detects a diffracted beam by the detection light incident on the hologram,
wherein a position of the recorded hologram is detected based on an output of the light detection unit.

2. The optical information recording and reproducing device according to claim 1, further comprising:
a mask unit that blocks the detection light transmitted through the hologram in the diffracted beam.

3. The optical information recording and reproducing device according to claim 1, wherein the light detection unit is divided into a plurality of regions and the position of the recorded hologram is detected based on a light amount detected in each of the regions.

4. The optical information recording and reproducing device according to claim 1, wherein the position of the hologram is detected with first detection light, and then the position of the hologram is detected with second detection light with a different light flux diameter from the first detection light.

5. The optical information recording and reproducing device according to claim 1,
wherein a unique pattern of each hologram is recorded at a time of recording of the hologram, and
wherein the unique pattern of the hologram to be detected is set as the detection light at a time of position detection.

6. The optical information recording and reproducing device according to claim 1,
wherein the detection light generation unit includes
a laser light source that generates laser light,
an optical element that changes polarization of the laser light generated by the laser light source, and
a splitter that splits the laser light passing through the optical element into signal beam and reference beam, and
wherein when data of the optical information recording medium is reproduced with the reference beam split by the splitter, light including a part of the signal beam split by the splitter is continuously generated as the detection light.

7. The optical information recording and reproducing device according to claim 1, further comprising:
a mask unit that blocks the detection light transmitted through the hologram; and
a cylindrical lens.

8. An optical information reproducing device that reproduces information using reference beam from an optical information recording medium on which an interference fringe obtained by interfering the reference beam and signal beam is recorded as a hologram, the optical information reproducing device comprising:
a detection light generation unit that generates light including a part of the signal beam as detection light;
a detection light incident unit that causes the detection light to be incident on the recorded hologram; and
a light detection unit that detects a diffracted beam by the detection light incident on the hologram,
wherein a position of the recorded hologram is detected based on an output of the light detection unit.

9. The optical information reproducing device according to claim 8, further comprising:
a mask unit that blocks the detection light transmitted through the hologram in the diffracted beam.

10. The optical information reproducing device according to claim 8, wherein the light detection unit is divided into a plurality of regions and the position of the recorded hologram is detected based on a light amount detected in each of the regions.

11. The optical information reproducing device according to claim 8, wherein the position of the hologram is detected with first detection light, and then the position of the hologram is detected with second detection light with a different light flux diameter from the first detection light.

12. The optical information reproducing device according to claim 8,
wherein a unique pattern of each hologram is recorded in the hologram, and
wherein the unique pattern of the hologram to be detected is set as the detection light at a time of position detection.

13. The optical information reproducing device according to claim 8,
wherein the detection light generation unit includes
a laser light source that generates laser light,
an optical element that changes polarization of the laser light generated by the laser light source, and
a splitter that splits the laser light passing through the optical element into signal beam and reference beam, and
wherein when data of the optical information recording medium is reproduced with the reference beam split by the splitter, light including a part of the signal beam split by the splitter is continuously generated as the detection light.

14. The optical information reproducing device according to claim 8, further comprising:
a mask unit that blocks the detection light transmitted through the hologram; and
a cylindrical lens.

15. An optical information reproducing device that reproduces information using reference beam from an optical information recording medium on which an interference fringe obtained by interfering the reference beam and signal beam is recorded as a hologram, the optical information reproducing device comprising:
a laser light source that generates laser light;
a splitter that splits the laser light generated by the laser light source into reference beam and detection light;
a reference beam optical system that guides the reference beam split by the splitter to an optical information recording medium;
a detection light incident unit that exposes the detection light split by the splitter in a direction in which the signal beam at a time of hologram recording is incident on the optical information recording medium;
a detector that receives a diffracted beam by the detection light passing through the detection light incident unit and incident on the optical information recording medium; and
a mechanism that adjusts an incident position of the reference beam on the optical information recording medium according to an output of the detector.
